(19) United States
(12) Patent Application Publication
(10) Pub. No.: US 2025/0082444 A1
(43) Pub. Date: Mar. 13, 2025

(54) DENTAL IMPLANT STRUCTURE

(71) Applicant: INNODEN Co., Ltd., Siheung-si, Gyeonggi-do (KR)

(72) Inventor: Cheon Seok JANG, Ansan-si, Gyeonggi-do (KR)

(73) Assignee: INNODEN Co., Ltd., Siheung-si, Gyeonggi-do (KR)

(21) Appl. No.: 18/280,661

(22) PCT Filed: Jun. 30, 2023
(86) PCT No.: PCT/KR2023/009200

§ 371 Date: Sep. 6, 2023

(30) Foreign Application Priority Data
Oct. 31, 2022 (KR) 10-2022-0142317

(51) Int. Cl. A61C 8/00

(52) U.S. Cl. CPC A61C 8/0068; A61C 8/0057; A61C 8/0062; A61C 8/0069

(57) ABSTRACT

The present invention relates to an abutment screw-separable dental implant structure in which an abutment is fastened and fixed to a fixture implanted in an alveolar bone through an abutment screw, and more particularly, to a dental implant structure in which, as a head part of an abutment screw protrudes upward from a post of an abutment without being accommodated in the abutment, a diameter (inner diameter) of an inner space of the abutment may be reduced to freely form a diameter and thickness of the post of the abutment to a desired size.

### TECHNICAL FIELD

The present invention relates to an abutment screw-separable dental implant structure in which an abutment is fastened and fixed to a fixture implanted in an alveolar bone through an abutment screw, and more particularly, to a dental implant structure in which, as a head part of an abutment screw protrudes upward from a post of an abutment without being accommodated in the abutment, a diameter (inner diameter) of an inner space of the abutment may be reduced to freely form a diameter and thickness of the post of the abutment to a desired size.

### BACKGROUND ART

A dental implant structure is basically a fixture that is implanted in an alveolar bone, an abutment that is fixed to the fixture and supports lateral or horizontal pressure in response to occlusal force applied during mastication, and a crown (artificial tooth) that restores an aesthetic beauty similar to a natural tooth by covering an upper portion of the abutment.

The abutment is fastened and fixed to the fixture through an abutment screw. Depending on the structure in which the abutment screw is coupled to the abutment, the abutment may be largely divided into an abutment screw-integrated abutment and an abutment screw-separable abutment. In the abutment screw-integrated abutment, the abutment screw is integrally formed with the abutment, and in the abutment screw-separable abutment, the abutment screw is separated from the abutment.

FIG. 1 is a cross-sectional view schematically illustrating the conventional abutment screw-separable abutment.

As illustrated in FIG. 1, the conventional abutment screw-separable abutment 2 is fastened and fixed to a fixture 1 through an abutment screw 3. The abutment screw 3 is formed on a threaded part 3a that is screwed to the fixture 1 and a head part 3b that is formed to have a larger diameter than that of the threaded part 3a and is caught downward with an inner jaw part 2d formed inside the abutment 2.

The conventional abutment screw-separable abutment 2 has a structure in which the head part 3b of the abutment screw 3 is accommodated inside the abutment 2, and thus, becomes an obstacle in forming the diameter or thickness of the abutment 2 to the targeted diameter or thickness. That is, as the head part 3b of the abutment screw 3 is formed to have a larger diameter than that of the threaded part 3a, a diameter (inner diameter) of an inner space 2e of the abutment 2 is also formed to have a larger diameter than that of the head part 3b corresponding to the diameter of the head part 3b, so it is difficult to form a post 2c of the abutment 2 to the targeted diameter or thickness.

Usually, a diameter (outer diameter) of the threaded part 3a of the abutment screw 3 is formed to be approximately 2.0 mm (standard screw diameter), and the head part 3b is formed to be approximately 2.3 to 2.4 mm larger than the diameter of the threaded part 3a by approximately 0.3 to 0.4 mm. Accordingly, a diameter d2 of an uppermost portion of the abutment 2 should be larger than a diameter d1 of the head part 3b of the abutment screw 3 by at least about 0.5 mm. Therefore, the diameter d2 of the uppermost portion of the post 2c of the abutment 2 should be at least 2.8 mm as illustrated in FIG. 1 (value obtained by summing the diameter d1 in 2.4 mm of the head part 3b of the abutment screw 3 and a thickness t1 in 0.4 mm (0.2 mm×2) of a metal material constituting the abutment 2).

In this way, in the abutment screw-separable abutment structure in which the head part 3b of the abutment screw 3 is accommodated inside, the diameter d2 of the post 2c of the abutment 2 should be at least 2.8 mm. This makes it difficult to apply an abutment having this structure to a mandibular anterior part. The mandibular anterior part is a part where a diameter of a tooth is relatively small, and in order to make mandibular teeth look natural, the diameter d2 of the post 2c of the abutment 2 is often required to be 2.8 mm or less. However, due to the above reasons, there are many cases where the conventional abutment structure cannot solve this problem. Also, when the diameter of the post 2c is reduced, an angle of an outer wall of the post is close to 90°, making it difficult to pass a crown.

### RELATED ART DOCUMENTS

### Patent Documents

(Patent Document 1) KR 10-2017-0102280 A, 2017. Sep. 8.
(Patent Document 2) KR 20-0467684 Y1, 2013. Jun. 21.
(Patent Document 3) KR 10-1210671 B1, 2012. Dec. 4.

### DISCLOSURE

### Technical Problem

As described above, since the inner space 2e for accommodating the head part 3b of the abutment screw 3 should be provided in the center of the abutment, the thickness (thickness from an outer surface to an inner surface) of the post 2c of the abutment 2 is inevitably formed to be smaller. In addition, in the case of the abutment 2 applied to a patient with a small tooth width, a cuff 2b is formed to have a relatively small diameter, and a lower end portion of the post 2c in contact with an upper end surface of the cuff 2b is also inevitably formed to be small corresponding to the small diameter of the cuff 2b. In addition, in a structure in which an elastic ring is coupled to the outer surface of the post to absorb the occlusal force, such as in Korean Patent No. 10-2323728, the diameter of the post is inevitably smaller in consideration of the thickness of the elastic ring.

This makes it more difficult to form a coupling groove in which the elastic ring is coupled around the outer surface of the post 2c of the abutment. For example, when forming the coupling groove along the outer circumference of the post 2c of the abutment, an unnecessary hole (a hole through which the outside of the post communicates with the inner space 2e) may be formed on a side portion of the post 2c, or it may be difficult to apply the elastic ring to the abutment due to structural weakness caused by the thinning of the thickness around the coupling groove.

Therefore, the present invention is proposed to solve the general problems of the related art, and the problem (object) to be solved provides a dental implant structure capable of overcoming structural limitations such as a diameter or a thickness of an abutment post by reducing a diameter of an inner space of the abutment in an abutment screw-separable abutment structure.

In addition, another problem of the present invention provides a dental implant structure capable of buffering occlusal force applied to repetitive mastication between a crown and an abutment while affecting a diameter and thickness of a post of an abutment, and stably forming a coupling groove to which an elastic ring for coupling between the crown and the abutment is coupled.

In addition, the present invention is not limited to the above-described purpose, and various objects may be additionally provided through technologies described through embodiments and claims to be described later.

### Technical Solution

According to an aspect of the present disclosure, there is provided an abutment screw-separable dental implant structure in which an abutment is fastened and fixed to a fixture implanted in an alveolar bone through an abutment screw, in which the abutment screw includes: a threaded part coupled to the fixture through an inner space of the abutment; a connecting part formed on an upper portion of the threaded part and caught downward with the abutment; and a head part formed on the upper portion of the connection portion and protruding toward the upper portion of the abutment.

The head part may have a smaller diameter upward from a lower portion.

A driver hole may be formed in the head part.

A vertical cutting surface may be formed on a side surface of the head part.

A coupling groove to which an elastic ring is coupled may be formed around the head part.

An elastic ring in a form of a C-ring or an O-ring may be coupled to the coupling groove.

The connection part may be accommodated in the inner space of the abutment.

A locking jaw part caught downward with an inner jaw part formed in an inner space of the abutment may be formed at a boundary between the threaded part and the connection part.

The connection part may be formed in a tapered structure having a diameter increasing toward the upper portion.

The abutment screw-separable dental implant structure may further include a crown installed to cover the head part and a post of the abutment, in which the crown may be provided with an accommodating groove part in which the head part and the post of the abutment are accommodated.

An elastomer may be installed between the accommodating groove part, the head part accommodated in the accommodating groove part, and a crown accommodating part including the post of the abutment.

The abutment screw-separable dental implant structure may further include an abutment cap coupled to the head part and accommodated in the accommodating groove part.

The abutment cap may include: a threaded part of the abutment cap screwed to the head part of the abutment screw; and a head part of the abutment cap formed on an upper portion of the threaded part of the abutment cap and pressing an inner wall of the accommodating groove part toward the abutment.

### Advantageous Effects

As described above, according to the present invention, by providing a new dental implant structure in which a head part of an abutment screw is not accommodated in an abutment but protrudes to an upper portion of a post of the abutment, it is possible to effectively reduce a diameter (inner diameter) of an inner space of the abutment and thus to freely form the post of abutment to a desired size without limiting a diameter and thickness thereof.

In addition, according to the present invention, by providing a new dental implant structure in which a coupling groove is formed on a head part of an abutment screw protruding upward from a post of an abutment and an elastic ring is coupled to the coupling groove, it is possible to stably couple a crown and the abutment without using an adhesive without affecting a diameter and thickness of the post of the abutment at all. In addition, it is possible to smoothly and stably detach the crown through the elastic ring and prevent an abutment and/or fixture etc., from being fractured by absorbing the repeatedly applied occlusal force.

In addition, according to the dental implant structure of the present invention, by forming an elastomer between an accommodating groove part formed in a crown and a crown accommodating part (part including a head part of an abutment screw and a post of an abutment) accommodated inside the crown accommodating groove to block a direct contact of the crown with the crown accommodating part, it is possible to secure an extra space in which a contraction and expansion of an elastic ring may be smoothly performed between the crown and the crown accommodating part, prevent the crown, abutment, and/or fixture etc., from being fractured due to a repetitive occlusal force by absorbing the occlusal force repeatedly applied to the crown using elastic force together with the elastic ring, and prevent foreign substances from entering between the crown and the abutment.

### DESCRIPTION OF DRAWINGS

FIG. 1 is a cross-sectional view schematically illustrating the conventional abutment screw-separable abutment.

FIG. 2 is an assembled cross-sectional view illustrating a dental implant structure according to a first embodiment of the present invention.

FIG. 3 is a cross-sectional view of a state in which an abutment screw is separated from the dental implant structure illustrated in FIG. 2.

FIG. 4 is a cross-sectional view illustrated for comparison between the first embodiment and a first comparative embodiment of the present invention.

FIG. 5 is an assembled cross-sectional view illustrating a dental implant structure according to a second embodiment of the present invention.

FIG. 6 is a cross-sectional view of a state in which an abutment screw is separated from the dental implant structure illustrated in FIG. 5.

FIG. 7 is an assembled cross-sectional view illustrating a dental implant structure according to a third embodiment of the present invention.

FIG. 8 is a cross-sectional view illustrated for comparison between a third embodiment and a second comparative embodiment of the present invention.

FIG. 9 is an assembled cross-sectional view illustrating a dental implant structure according to a fourth embodiment of the present invention.

FIG. 10 is a cross-sectional view illustrating a state in which a crown is coupled in FIG. 9.

FIG. 11 is a cross-sectional view illustrating a dental implant structure according to a fifth embodiment of the present invention.

FIG. 12 is a cross-sectional view illustrating a dental implant structure according to a sixth embodiment of the present invention.

### MODE FOR INVENTION

Various advantages and features of the present invention and methods accomplishing them will become apparent from the following description of embodiments with reference to the accompanying drawings. Also, like reference numerals designate like elements throughout this specification. In addition, each component illustrated in each figure may be excessively illustrated in size and shape, which is for convenience of description and is not intended to be limited. In addition, when described as “A and/or B,” it may mean both A and B, or either A or B.

In order to achieve the above-described problem (object), the present invention provides a new dental implant structure in which a head part of an abutment screw protrudes upward from a post of an abutment without accommodated inside the abutment. That is, in the dental implant structure according to the present invention, the head part of the abutment screw protrudes to the upper portion of the post of the abutment to reduce the diameter (inner diameter) of the abutment, so a diameter and thickness of the post of the abutment may be freely formed to the desired size.

Hereinafter, embodiments of the present invention will be described in detail with reference to the accompanying drawings.

### First Embodiment

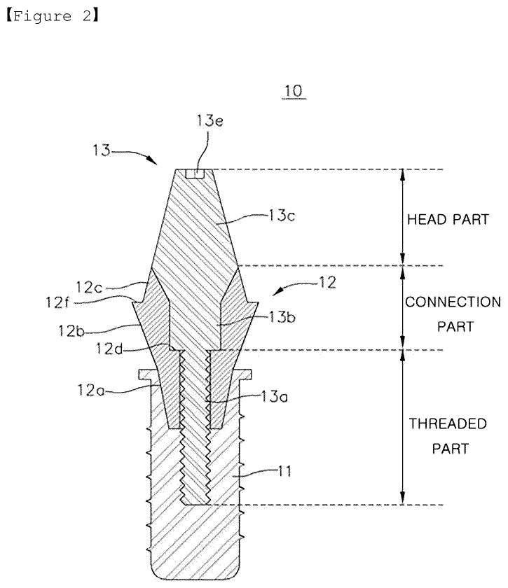

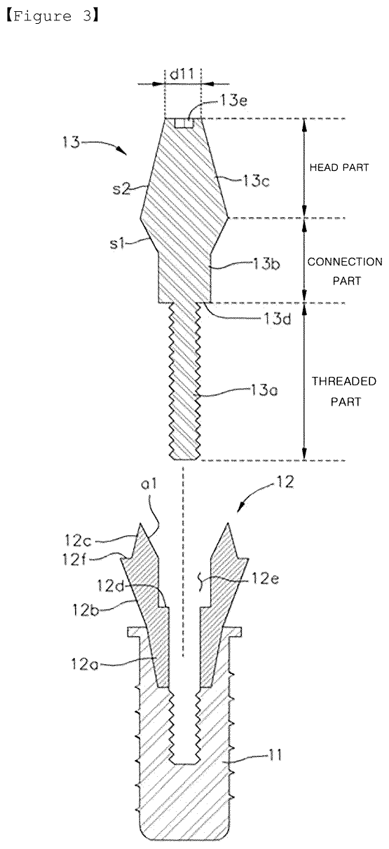

FIG. 2 is a cross-sectional view schematically illustrating a dental implant structure according to a first embodiment of the present invention, and FIG. 3 is a cross-sectional view of a state in which an abutment screw is separated from the dental implant structure illustrated in FIG. 2. Here, a crown is omitted for convenience of description.

Referring to FIGS. 2 and 3, a dental implant structure 10 according to the first embodiment of the present invention is coupled through an inner space (hollow) 12e of an abutment 12, and the upper portion includes an abutment screw 13 protruding to an upper portion of a post 12c of the abutment 12.

The abutment screw 13 includes a threaded part 13a screwed to a fixture 11 implanted in an alveolar bone and a connection part 13b formed on an upper portion of the threaded part 13a and accommodated in an inner space 12e of the abutment 12 as illustrated in FIG. 3, and includes a head part 13c formed on the upper portion of the connection part 13b to protrude to the upper portion of the post 12c of the abutment 12 as illustrated in FIG. 2.

A locking jaw part 13d caught downward with an inner jaw part 12d of the abutment 12 is formed at a boundary between the threaded part 13a and the connection part 13b. The connection part 13b may have a tapered structure in which an outer surface of a lower portion connected to the threaded part 13a has a vertical surface and the outer surface has an inclined surface so that the upper portion connected to the head part 13c has an increasing diameter.

Meanwhile, when the inner jaw part 12d of the abutment 12 is not formed and the function of the locking part is performed by a tapered part a1, the locking jaw part 13d of the abutment screw 13 may be omitted. In this case, a tapered surface s1 of the abutment screw 13, which is depressed inside the post 12c of the abutment 12, is in contact with the tapered portion al of the abutment 12 and is caught into each other.

As illustrated in FIG. 2, the head part 13c is a part that protrudes to the upper portion of the post 12c of the abutment 12 and is accommodated in an inside of a crown (not illustrated) together with the post 12c of the abutment 12, and may be stably accommodated in the crown by having a tapered structure in which the outer surface has an inclined surface so that the diameter decreases from the lower portion to the upper portion. In addition, a driver hole 13e into which a driver tool is inserted may be formed at an upper end portion of the head part 13c.

As illustrated in FIG. 3, the abutment 12 includes a coupling part 12a that is coupled to the fixture 11, a cuff 12b that is formed on the upper portion of the coupling portion 12a and formed in a tapered structure in which an outer surface is an inclined surface to increase a diameter, and a post 12c that is formed on the upper portion of the cuff 12b, formed in a tapered structure in which an outer surface has an inclined surface to decrease a diameter, and accommodated in the crown. An outer jaw portion 12f having a step is formed at the boundary between the cuff 12b and the post 12c.

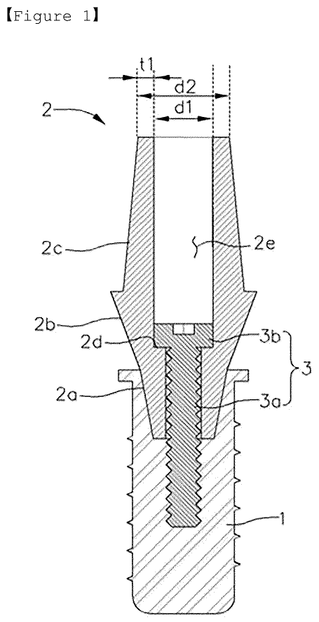

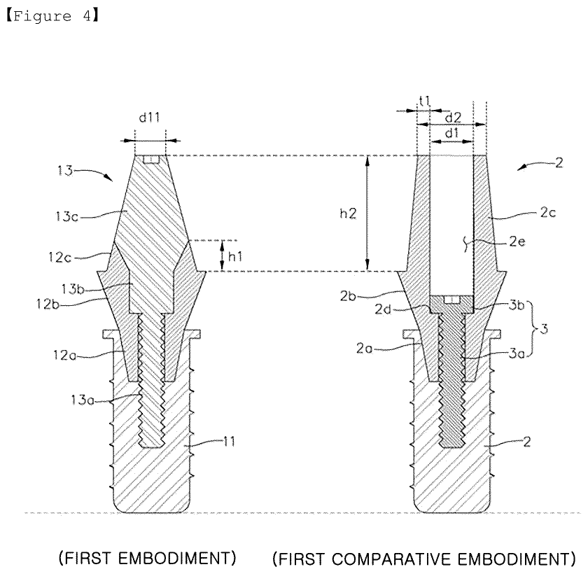

FIG. 4 is a cross-sectional view schematically illustrated for comparison between the first embodiment and a first comparative embodiment of the present invention. Here, the first comparative embodiment has the same structure as the related art example illustrated in FIG. 1.

Referring to FIG. 4, in the first embodiment of the present invention, a height h1 of the post 12c of the abutment 12 is formed to be smaller than a height h2 of the post 2c of the abutment 2 according to the first comparative embodiment.

In the first embodiment of the present invention, the head part 13c of the abutment screw 13 protrudes upward from the post 12c of the abutment 12, and thus, partially replaces the role (coupling with the crown) of the post 2c of the abutment 2 in the conventional implant structure as in the first comparative embodiment. Through this, it can be freely formed regardless of a diameter or thickness t1 of an inner space 2e of the post of the abutment 2, which has been a problem in the conventional implant structure.

In addition, in the implant structure as in the first comparative embodiment, since the inner space 2e in which a head part 3b of the abutment screw 3 is accommodated is essentially formed inside the abutment 2, the thickness t1 of the post 2c of the abutment 2 is inevitably reduced by the diameter of the inner space 2e, so the strength may be weakened and the risk of fracture may increase. However, in the first embodiment of the present invention, as the abutment screw 13 is formed in a non-hollow structure, an upper diameter d11 is thicker than the thickness t1 of the post 2c of the first comparative embodiment, so the strength may be improved.

### Second Embodiment

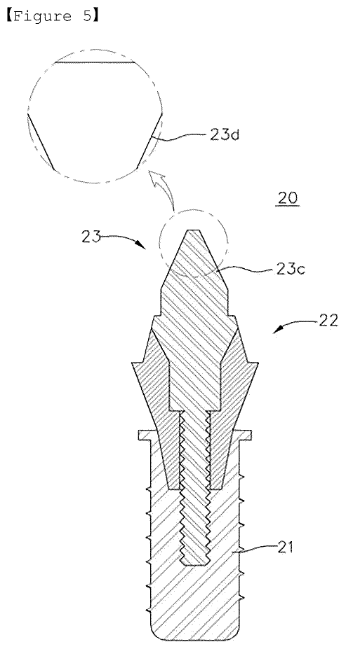

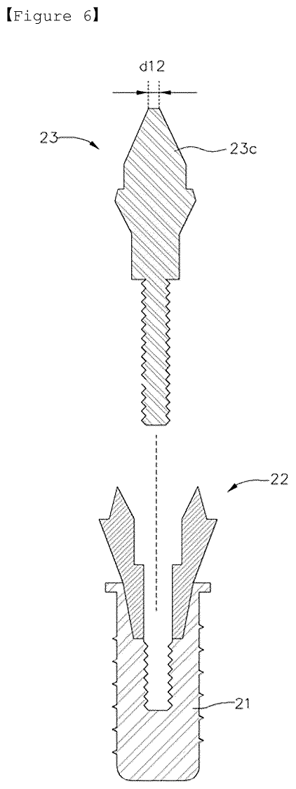

FIG. 5 is a cross-sectional view schematically illustrating a dental implant structure according to a second embodiment of the present invention, and FIG. 6 is a cross-sectional view of a state in which an abutment screw is separated from the dental implant structure illustrated in FIG. 5. Here, a crown is omitted for convenience of description.

Referring to FIGS. 5 and 6, a dental implant structure 20 according to the second embodiment of the present invention includes a fixture 21, an abutment 22, and an abutment screw 23 as in the first embodiment. However, in the second embodiment, a diameter d12 of a head part 23c of the abutment screw 23 accommodated inside the crown is formed to be smaller than in the first embodiment.

In the second embodiment, instead of forming a driver hole in the head part 23c of the abutment screw 23, a vertical cutting surface 23d (refer to the original design) is formed on the outer surface of the head part 23c to tighten or loosen the abutment screw 23 using a tool such as a ratchet. Therefore, in the second embodiment, by forming a vertical cutting surface 23d on the outer surface instead of forming the driver hole in the head part 23c of the abutment screw 23, compared to the diameter d11 of the head part 13c of the abutment screw 13 according to the first embodiment, the diameter d12 of the head part 23c of the abutment screw 23 may be formed smaller.

### Third Embodiment

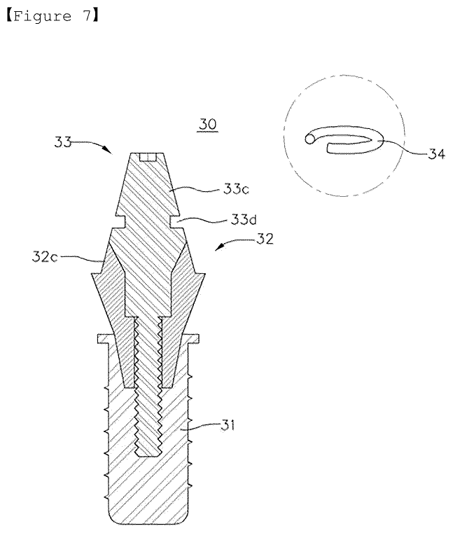

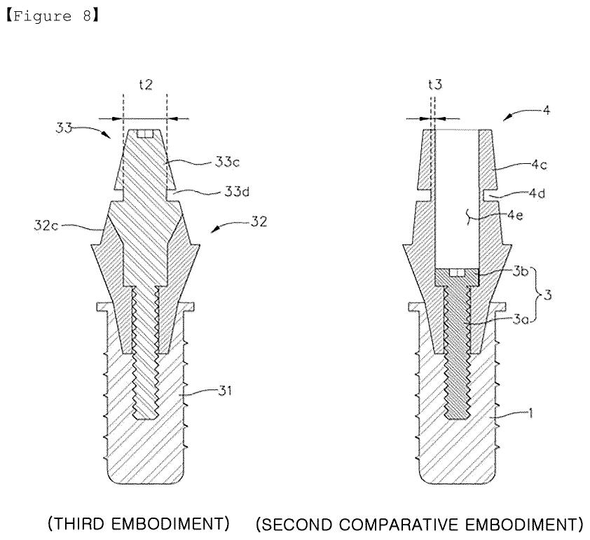

FIG. 7 is a cross-sectional view schematically illustrating a dental implant structure according to a third embodiment of the present invention, and FIG. 8 is a cross-sectional view schematically illustrated for comparison between the third embodiment of the present invention and a second comparative embodiment. Here, a crown is omitted for convenience of description.

Referring to FIG. 7, a dental implant structure 30 according to the third embodiment of the present invention includes a fixture 31, an abutment 32, and an abutment screw 33 as in the first embodiment. However, in the third embodiment 3, a coupling groove 33d to which an elastic member formed of a ring structure, that is, an elastic ring 34 (refer to the original design) is coupled to a circumference of the head part 33c of the abutment screw 33 is formed in a band shape. In this case, one or two or more coupling grooves 33d may be formed.

The elastic ring 34 may be formed of a C-ring or O-ring structure, and when the elastic ring 34 is formed of the O-ring structure, the elastic ring 34 may be formed of a ring made of a silicone rubber material, a synthetic rubber material, or a woven thin nitinol wire. In addition, in the case of the C-ring structure, a metal film such as nitinol or plastic may be used. The elastic ring 34 buffers an impact caused by occlusal force applied to the crown during mastication between the crown and a post 32c of the abutment and the head part 33c of the abutment screw 33, and allows the crown to be coupled to the abutment 32 and the abutment screw 33 without using an adhesive, and prevents the crown from falling off undesirably.

In addition, in the implant structure as in the second comparative embodiment, since an inner space 4e in which the head part 3b of the abutment screw 3 is accommodated is formed inside the abutment 4, a thickness of a post 4c of the abutment 4 decreases by the diameter of the inner space 4e, and when a coupling groove 4d is additionally formed inside the abutment 4, a thickness t3 of the post 4c of the abutment 4 further decreases in the portion where the coupling groove 4d is formed, and thus, a hole is drilled during the formation process of the coupling groove 4d, thereby causing a problem in that the post 4c of the abutment 4 communicates with the inner space 4e. However, in the third embodiment 3, since a hollow is not formed in the head part 33c of the abutment screw 33, a sufficient thickness t2 is secured, so the problems in the implant structure as in the second comparative embodiment do not occur.

That is, as illustrated in FIG. 8, in the second comparative embodiment, the inner space 4e is formed in the abutment 4, but in the third embodiment, an empty space is not formed in the head part 33c of the abutment screw 33 protruding outward from the post 32c of the abutment 32. Accordingly, even if the coupling groove 33d is formed around the head part 33c of the abutment screw 33, structural problems do not occur due to the thickness of the head part 33c of the abutment screw 33.

When manufacturing the crown, a circumferential groove (not illustrated) into which a part of the elastic ring 34 is inserted may be formed around an inner circumference of the crown corresponding to the elastic ring 34. When the crown is seated on the post 32c of the abutment 32, the elastic ring 34 is coupled to a circumferential groove formed inside the crown and a coupling groove 33d formed on the head part 33c of the abutment screw 33 in a horizontal state. Through this, the crown may be fixed to the abutment 32 without using an adhesive.

Meanwhile, when the crown is seated, the post 32c of the abutment 32 and the head part 33c of the abutment screw 33 are accommodated in the accommodating groove part inside the crown. Hereinafter, for convenience of description, the post 32c of the abutment 32 and the head part 33c of the abutment screw 33 accommodated inside the accommodating groove part formed inside the crown are collectively referred to as “crown accommodating part.” An elastomer (not illustrated) having elasticity may be inserted between the crown accommodating part and the crown accommodating groove part to manufacture the crown that flows in response to the occlusal force. In this case, the elastomer may be coated or adhered to the outer surface of the crown accommodating part. Alternatively, the elastomer may be coated or adhered to an inner wall of the accommodating groove part of the crown. Alternatively, the elastomer may be formed thin as an independent product and inserted between the crown accommodating part and the crown accommodating groove part.

### Fourth Embodiment

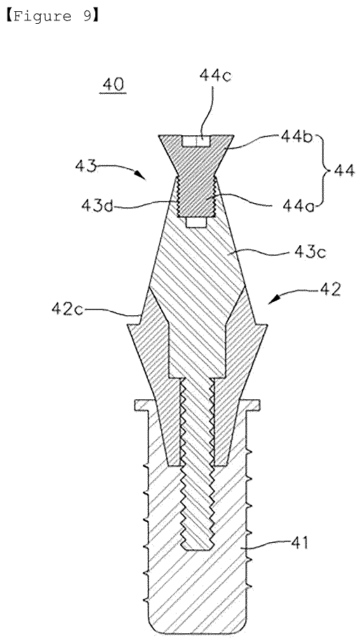

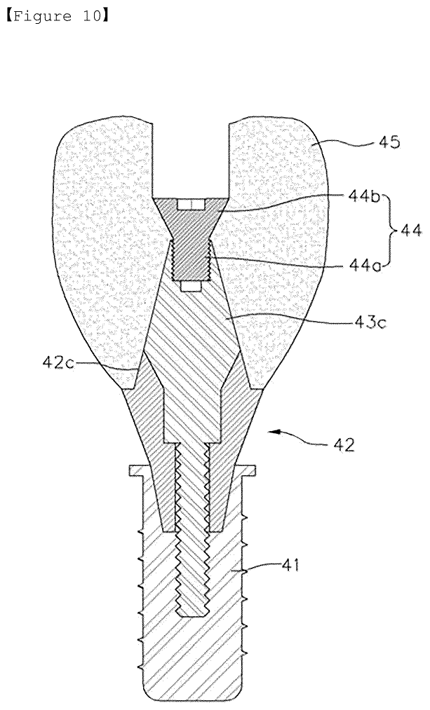

FIG. 9 is an assembled cross-sectional view schematically illustrating a dental implant structure according to a fourth embodiment of the present invention, and FIG. 10 is a cross-sectional view schematically illustrating a state in which the crown is coupled in FIG. 9.

Referring to FIGS. 9 and 10, a dental implant structure 40 according to the fourth embodiment of the present invention includes a fixture 41, an abutment 42, and an abutment screw 43 as in the first embodiment. In addition, in order to more stably fix a crown 45 tightly to a post 42c of the abutment 42 and a head part 43c of the abutment screw 43, the dental implant structure 40 includes an abutment cap 44 screwed to an upper portion of the abutment screw 43.

The abutment cap 44 includes a threaded part 44a coupled to the head part 43c of the abutment screw 43. The threaded part 44a is screwed to a screw groove part 43d of the head part 43c of the abutment screw 43 through a thread 141a formed on an outer circumferential surface. In addition, the abutment cap 44 includes a head part 44b formed on the upper portion of the threaded part 44a. A driver hole 44c for coupling a driver tool when assembling or disassembling the abutment cap 44 to the head part 43c of the abutment screw 43 may be formed in a central upper portion of the head part 44b. In this case, the driver hole 44c may be formed in, for example, a hexa (hexagonal) shape, a star shape, a cross shape, and the like. Meanwhile, as illustrated in FIG. 10, in order to tightly fix the crown 45, the head part 44b of the abutment cap 44 has a tapered structure having an inclined surface whose outer surface corresponds to an inner side surface of the crown 45 and increases in diameter toward the upper portion. Alternatively, it may have a ‘T’-shaped structure.

### Fifth Embodiment

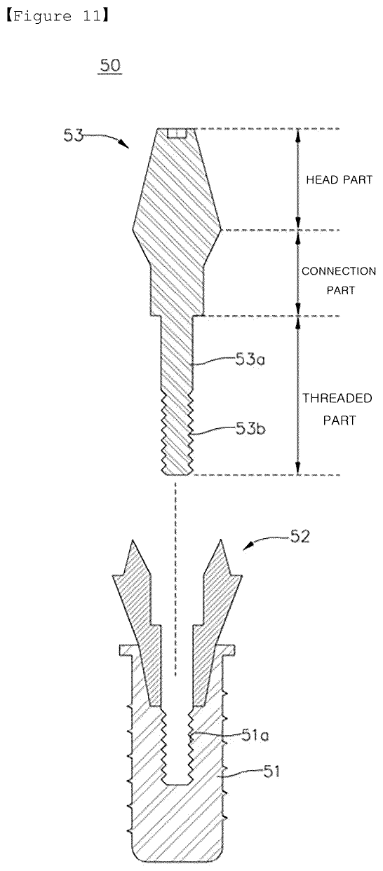

FIG. 11 is a cross-sectional view schematically illustrating a dental implant structure according to a fifth embodiment of the present invention, and is a diagram illustrating a state in which the abutment screw is separated from the abutment.

Referring to FIG. 11, a dental implant structure 50 according to the fifth embodiment of the present invention includes a fixture 51, an abutment 52, and an abutment screw 53 as in the first embodiment. However, unlike the first embodiment, a threaded part 53a of the abutment screw 53 does not have a thread 53b formed over the entire upper and lower portion of the threaded part 53a, but is substantially is formed only on the lower portion that is substantially screwed into the screw thread 51a formed on the fixture 51.

### Sixth Embodiment

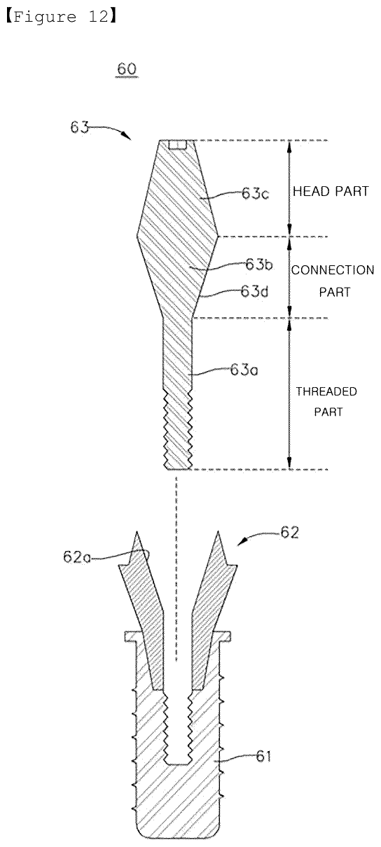

FIG. 12 is a cross-sectional view schematically illustrating a dental implant structure according to a sixth embodiment of the present invention, and is a diagram illustrating a state in which the abutment screw is separated from the abutment.

Referring to FIG. 12, a dental implant structure 60 according to the sixth embodiment of the present invention includes a fixture 61, an abutment 62, and an abutment screw 63 as in the fifth embodiment. However, unlike the fifth embodiment, an outer surface 63d of a connection part 63b of the abutment screw 63 has a tapered structure having an inclined surface whose diameter increases toward a head part 63c. In addition, an inner surface 62a of the abutment 62 contacting an outer surface 63d of the connection part 63b also has a tapered structure having the same inclined surface as the inclined surface of the connection part 63b.

Meanwhile, the abutment screws 13, 23, 33, 43, 53, and 63 proposed in the first to sixth embodiments of the present invention has a structure in which the diameter decreases from the lower portion to the upper portion. That is, the head parts 13c, 23c, 33c, 43c, 53c, and 63c have a tapered structure in which the diameter decreases from the abutment side toward the upper portion. In addition, the head parts 13c, 23c, 33c, 43c, 53c, and 63c may have a cylindrical structure. Through this structure, the head parts 13c, 23c, 33c, 43c, 53c, and 63c may be easily accommodated in the crown.

Hereinabove, although preferred embodiments of the present invention have been described and illustrated using specific terms, such terms are only intended to clarify the present invention. It is obvious that various modifications and changes may be made to the embodiments of the present invention and the described terms without departing from the technical spirit and scope of the following claims. Such modified embodiments should not be individually understood from the spirit and scope of the present invention, and it is to be understood that the embodiments of the present invention fall within the scope of the claims of the present invention.

1. An abutment screw-separable dental implant structure in which an abutment is fastened and fixed to a fixture implanted in an alveolar bone through an abutment screw, wherein the abutment screw comprises:
a threaded part coupled to the fixture through an inner space of the abutment;
a connecting part formed on an upper portion of the threaded part and caught downward with the abutment;
a head part formed on the upper portion of the connection portion and protruding toward the upper portion of the abutment;
a crown installed to cover the head part and a post of the abutment,
the crown being provided with an accommodating groove part in which the head part and the post of the abutment are accommodated, and
an abutment cap coupled to the head part and accommodated in the accommodating groove part.

2. The abutment screw-separable dental implant structure of claim 1, wherein the head part has a smaller diameter upward from a lower portion.

3. The abutment screw-separable dental implant structure of claim 1, wherein a driver hole is formed in the head part.

4. The abutment screw-separable dental implant structure of claim 1, wherein a vertical cutting surface is formed on a side surface of the head part.

5. The abutment screw-separable dental implant structure of claim 1, wherein a coupling groove to which an elastic ring is coupled is formed around the head part.

6. The abutment screw-separable dental implant structure of claim 5, wherein an elastic ring in a form of a C-ring or an O-ring is coupled to the coupling groove.

7. The abutment screw-separable dental implant structure of claim 1, wherein the connection part is accommodated in the inner space of the abutment.

8. The abutment screw-separable dental implant structure of claim 1, wherein a locking jaw part caught downward with an inner jaw part formed in an inner space of the abutment is formed at a boundary between the threaded part and the connection part.

9. The abutment screw-separable dental implant structure of claim 1, wherein the connection part is formed in a tapered structure having a diameter increasing toward the upper portion.

10. The abutment screw-separable dental implant structure of claim 1, wherein an elastomer is installed between the accommodating groove part, the head part accommodated into the accommodating groove part, and a crown accommodating part including the post of the abutment.

11. The abutment screw-separable dental implant structure of claim 1, wherein the abutment cap comprises:
a threaded part of the abutment cap screwed to the head part of the abutment screw; and
a head part of the abutment cap formed on an upper portion of the threaded part of the abutment cap and pressing an inner wall of the accommodating groove part toward the abutment.
